(19) United States
(12) Patent Application Publication
(10) Pub. No.: US 2011/0158470 A1
(43) Pub. Date: Jun. 30, 2011

(54) METHOD AND SYSTEM FOR SECURE CODING OF ARBITRARILY SHAPED VISUAL OBJECTS

(76) Inventors: Karl Martin, Toronto (CA); Konstantinos Plataniotis, Toronto (CA)

(21) Appl. No.: 13/002,192

(22) PCT Filed: Jun. 19, 2009
(86) PCT No.: PCT/CA09/00842

§ 371 Date: Dec. 30, 2010

(30) Foreign Application Priority Data
Aug. 11, 2008 (US) 61087860

(51) Int. Cl. G06K 9/00

(52) U.S. Cl. 382/100

(57) ABSTRACT

The present invention relates to a method and system for secure coding of arbitrarily shaped visual objects. More specifically, a system and method are provided for encoding an image, characterized by the steps of selecting one or more objects in the image from the background of the image, separating the one or more objects from the background, and compressing and encrypting, or facilitating the compression and encryption, by one or more computer processors, each of the one or more objects using a single coding scheme. The coding scheme also is operable to decrypt and decode each of the objects.

### FIELD OF INVENTION

The present invention relates to a method and system for secure coding of arbitrarily shaped visual objects. More specifically, the present invention relates to a secure visual object coder that provides both compression and reversible encryption using a single scheme.

### BACKGROUND OF THE INVENTION

Video surveillance of both public and private spaces is expanding at an ever-increasing rate. Consequently, individuals are increasingly concerned about the invasiveness of such ubiquitous surveillance and fear that their privacy is at risk. The demands of law enforcement agencies to prevent and prosecute criminal activity, and the need for private organizations to protect against unauthorized activities on their premises are often seen to be in conflict with the privacy requirements of individuals.

One class of existing schemes addressing privacy protection in video surveillance employs scrambling, obscuring, or masking techniques to protect the identity of the subjects [5]-[8]. In these schemes, the visual texture data of the subject's face or whole body are discarded or irreversibly transformed. These schemes disallow the use of the content for future investigative purposes and ultimately limit the efficacy of the surveillance system in which they are utilized. In [5], the subject's body image is masked, revealing only a silhouette. However, such a silhouette may still allow identification of the subject via biometric modalities such as gait [9]. Similarly, in [6], the focus is on removing appearance information while retaining structural information about the body in order to assess behavior. The approach in [7] is to ‘de-identify’ face images so that facial recognition software cannot be used to reliably identify the subject, but enough facial features remain so that the image could still be used for detecting behavior. In this so-called k-Same approach, face images are clustered based on a distance metric, and the images replaced by a representative image generated by averaging of components based on pixels or eigenvectors. This approach, however, does not obscure the whole body image, and again, the original data is discarded and cannot be retrieved by authorized users. In [8], colored markers are worn by subjects who wish to have their face obscured in a particular surveillance environment. Employing AdaBoost to learn the marker's color model and Particle Filtering to track the marker from frame-to-frame, the subject is tracked in real-time and an elliptical mask placed over the head region. However, the scheme may not be practical in public scenarios as it requires subjects to “opt-out” through the use of the colored marker.

Another class of privacy protection schemes attempts to separate private features from the input signal and secure them in a fashion so that they may still be retrieved for future use [10]-[13]. In [10], a region of interest (ROI) is defined for face data within a frame, and the corresponding coefficients downshifted in order to be coded and protected in a separate quality layer using Motion JPEG 2000 [14]. However, using a traditional, non-shape-adaptive wavelet transform, the wavelet domain separation of ROI content only allows for rough separation of content in the spatial domain, thus disallowing precise object vs. background separation possible with object-based coding.

The computer vision approach of [1] provides three policy-dependent options to hiding privacy data: summarization; transformation (obscuration); and encryption. In the case of encrypted output, traditional encryption is applied to the entire private data stream, which is computationally infeasible in many digital video surveillance systems. The scheme proposed in [12] embeds the private information of subjects as an encrypted watermark within the surveillance frames. However, the private data is limited to rectangular regions of the image frame and the utilization of traditional encryption and watermarking may be computationally burdensome. In [13], a reversible wavelet-domain scrambling is performed on ROI-defined private data, thus allowing subsequent retrieval of the private data by authorized users. This approach, as in [10], does not allow explicit spatial domain separation of the object of interest and the background, and the region-of-interest shape is not secured. Furthermore, the scrambling is performed before compression, resulting in a modest reduction in coding performance [13]. In summary, ROI-based approaches simply provide special treatment to objects of interest within an image or video, but do not store those objects as completely separate entities.

A variety of image and video content protection schemes exist for entertainment applications [15], [16]. The techniques employed generally place an emphasis on standards compliance to ensure compatibility with the plethora of existing consumer devices and content delivery systems. However, these techniques may not be directly applicable to privacy-protected surveillance applications, where system operators may demand a greater level of confidentiality over the content and the system must support a mechanism for separation of private content while still maintaining the efficacy of the surveillance system. The schemes in [15] use efficient encryption or shuffling of variable-length codeword concatenations to secure MPEG-4 video streams while maintaining format compliance. However, entire frames are secured and hence cannot be used to secure only private data in surveillance applications. Furthermore, some image details may be reconstructed through error concealment techniques [15]. In [16], MPEG-4 video objects are secured through selective encryption of Object Descriptors (OD). This approach, however, offers very limited security since only meta-data is secured and none of the actual object content is encrypted.

What is required is an approach that uses a single scheme to compress and encrypt an object in an image that is separated from the image background, and that enables the decompression and decryption of that information to recreate the image given an appropriate decryption key.

### SUMMARY OF THE INVENTION

The present invention provides a computer implementable method for securely encoding an image, the method characterized by the steps of: (a) selecting one or more objects in the image from the background of the image; (b) separating the one or more objects from the background; and (c) compressing and encrypting, or facilitating the compression and encryption, by one or more computer processors, each of the one or more objects using a single coding scheme.

The present invention also provides a computer implementable method for encoding an image using a secure ST-SPIHT (Shape and Texture Set Partitioning in Hierarchical Tree) scheme, the method characterized by the steps of: (a) selecting an object from the image; (b) obtaining in a first color space a matrix of color texture samples of the image; (c) obtaining a shape mask of spatial positions inside the object and outside the object; (d) converting the matrix to a converted matrix in a second color space and applying the shape mask to the converted matrix; (e) transforming the converted matrix to a transformed matrix using a shape-adaptive discrete wavelet transform; (f) coding, or facilitating the coding, by one or more computer processors, the transformed matrix and the shape mask with a ST-SPIHT coder to produce a unified embedded output bit-stream; and (g) selectively encrypting the output bit-stream using a stream cipher applied to individual bits using a private key.

The present invention further provides a computer implementable method for decoding an image using a secure ST-SPIHT (Shape and Texture Set Partitioning in Hierarchical Tree) scheme, the method characterized by the steps of: (a) decrypting an output bit-stream using a stream cipher applied to individual bits using a private key; (b) decoding, or facilitating the decoding, by one or more computer processors, the bit-stream using a ST-SPIHT decoder to provide incremental instructions to the decryption stream cipher as to which bits to decrypt, and obtain a transformed matrix and a shape mask; (c) inverse transforming the transformed matrix to a converted matrix in a second color space using an inverse shape-adaptive discrete wavelet transform; and (d) converting the converted matrix to a matrix in a first color space for representing color texture samples of the image.

The present invention yet further provides a computer system for securely encoding an image, the computer system comprising one or more computers configured to provide, or provide access to, a secure coding and decoding utility, the secure coding and decoding utility characterized in that it is operable to: (a) select one or more objects in the image from the background of the image; (b) separate the one or more objects from the background; and (c) compress and encrypt, or facilitate the compression and encryption, by one or more computer processors, each of the one or more objects using a single coding scheme.

The present invention still further provides a computer program product for securely encoding an image, the computer program product comprising computer instructions and data which when made available to one or more computer processors configure the one or more computer processors to provide a secure encoding and decoding utility, the secure encoding and decoding utility characterized in that it is operable to: (a) select one or more objects in the image from the background of the image; (b) separate the one or more objects from the background; and (c) compress and encrypt, or facilitating the compression and encryption, by one or more computer processors, each of the one or more objects using a single coding scheme.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DESCRIPTION OF THE DRAWINGS

FIG. 1 illustrates the present invention implemented on a computer system wherein the secure coding and decoding utility is a computer program executable on the computer system.

FIG. 2 illustrates the present invention implemented as a service.

FIG. 3 illustrates the coding and decoding Secure ST-SPIHT system.

FIG. 4 illustrates the Secure ST-SPIHT coder.

FIG. 5 illustrates a composition subset of Bn of ST-SPIHT bit-stream for n>λ.

FIG. 6 illustrates the Secure ST-SPIHT decoder.

FIG. 7A illustrates the visual test object (original frame).

FIG. 7B illustrates the visual test object as a segmented object.

FIG. 7C illustrates the visual test object as a rectangular segmented object.

FIG. 8A illustrates the decrypted/decoded output objects when the correct decryption key is provided.

FIG. 8B illustrates the decrypted/decoded output objects when the incorrect decryption key is provided.

FIG. 8C illustrates the decrypted/decoded output objects when the incorrect decryption key is provided but the shape is available externally and only the texture is coded and encrypted.

FIG. 8D illustrates the decrypted/decoded output objects when the correct decryption key is provided.

FIG. 8E illustrates the decrypted/decoded output objects when the incorrect decryption key is provided.

FIG. 8F illustrates the decrypted/decoded output objects when the incorrect decryption key is provided but the shape is available externally and only the texture is coded and encrypted.

FIG. 8G illustrates the decrypted/decoded output objects when the correct decryption key is provided.

FIG. 8H illustrates the decrypted/decoded output objects when the incorrect decryption key is provided.

FIG. 8I illustrates the decrypted/decoded output objects when the incorrect decryption key is provided but the bounding box shape is available externally and only the texture is coded.

FIG. 8J illustrates the decrypted/decoded output objects when the correct decryption key is provided.

FIG. 8K illustrates the decrypted/decoded output objects when the incorrect decryption key is provided.

FIG. 8L illustrates the decrypted/decoded output objects when the incorrect decryption key is provided but the bounding box shape is available externally and only the texture is coded.

FIG. 9A illustrates the fraction of the output code bits which are encrypted vs. the number of coding iterations during which encryption is performed where the shape is not coded.

FIG. 9B illustrates the fraction of the output code bits which are encrypted vs. the number of coding iterations during which encryption is performed where the shape code is completed during the first coding iteration.

FIG. 9C illustrates the fraction of the output code bits which are encrypted vs. the number of coding iterations during which encryption is performed where the shape code is completed during the second coding iteration.

FIG. 9D illustrates the fraction of the output code bits which are encrypted vs. the number of coding iterations during which encryption is performed where the shape code is completed during the third coding iteration.

### DETAILED DESCRIPTION OF THE INVENTION

### Overview

The present invention provides a secure coding and decoding system and method for both compression and protection of selected objects within digital images or video frames, for example compression and protection of facial image data of persons appearing in surveillance video. The coding and decoding scheme used in the system and method of the present invention is a shape and texture set partitioning in hierarchical trees (ST-SPIHT) scheme (the secure coding and decoding scheme is referred to herein as Secure ST-SPIHT or SecST-SPIHT). SecST-SPIHT provides a single scheme for both compression and selective encryption of an object in an image that is separated from the image background. Advantageously, SecST-SPIHT is also operable to decrypt the object streams that are securely coded.

SecST-SPIHT employs object-based coding that enables the explicit separation of an object's shape and texture from background imagery, offering a finer level of content granularity not present in ROI-based schemes. The selective encryption scheme used by SecST-SPIHT minimizes processing overhead by encrypting the minimum amount of output code bits required to decode the original object shape and texture.

The present invention includes: (1) selection of one or more arbitrarily shaped objects for encoding from a digital image or video frame; (2) encoding the object shape and texture to achieve lossy or lossless compression; (3) selectively encrypting certain significant bits of the coded objects for efficient enforcement of confidentiality; (4) decrypting the encrypted bits; and (5) decoding the objects.

In the present invention, “selective encryption” refers to the fact that bits in the coded object of interest can be encrypted; encryption can be applied to certain significant code bits and not others; security of different strengths can be achieved depending on the number of bits encrypted. Because texture and shape are different data entities, these can be encoded and encrypted separately as well. The selective encryption method and scheme of the present invention minimizes processing overhead by encrypting the minimum amount of output code bits required to decode the original object shape and texture.

The present invention can be implemented using known encryption methods, for example, encryption that is reversible with a key. In accordance with the encoding method described herein, decryption of the encrypted image portions enables retrieval of substantially all of the original information.

Another advantage of the present invention is the ability to code for lossless compression (incurring no loss of data in the encoding and decoding process) or to code for lossy compression (for variable, optimized trade-off between data loss and achieved compression rate during the encoding and decoding process).

The present invention also includes or is linked to means for identifying areas of interest in a digital image for encoding and encryption, for example, a shape or object recognition tool for detecting faces of individuals or other aspects of the digital images where there may be a privacy or confidentiality interest. The present invention applies compression and encryption based on parameters associated with particular object data as detailed below. This improves computational efficiency and offers the flexibility to treat each object completely independently.

The encoding method of the present invention includes the steps of: (1) selecting an object of interest from a digital image; (2) obtaining a two dimensional matrix of three component RGB color texture samples of the image; (3) obtaining a two dimensional matrix (shape mask) of binary values where the value “1” denotes spatial positions inside the object and value “0” denotes spatial positions outside the object; (4) pre-processing the image by converting the texture of the object to the YC_{b}Cᵣ color space and setting texture positions outside the object to zero; (5) transforming the YC_{b}Cᵣ texture data using a shape-adaptive discrete wavelet transform; (6) coding the transformed texture data and the shape mask with a ST-SPIHT coder to produce a unified embedded output bit-stream; and (7) encrypting the output bit-stream using a stream cipher applied to individual significant bits using a private key.

The decoding method of the present invention includes the steps of: (1) incrementally decrypting and decoding an output bit-stream using (a) a stream cipher and private key, and (b) a ST-SPIHT decoder operating in tandem to identify which bits required decoding and which bits require decryption and decoding to obtain a transformed texture data and a two dimensional matrix (shape mask) of binary values, where the value “1” denotes spatial positions inside the object and value “0” denotes spatial positions outside the object; (2) inverse transforming the transformed texture data using an inverse shape-adaptive discrete wavelet transform; and (3) post-processing the YC_{b}Cᵣ texture data to obtain the texture of an object in the RGB color space.

### Potential Applications

The present invention may be used in any application which involves the acquisition, transmission, or storage of visual data containing objects that may be deemed confidential or private, or any other instance where selective encryption is desirable. For surveillance applications, the objects may be human face or body images, images of text content such as signs or documents, or any other visual data of arbitrary shape and texture. In social networking applications involving the sharing of images and video, the invention may be used to enforce the privacy of face or full body images appearing in the shared images and videos, for example selective protection of children appearing in digital photos to be distributed on the Internet. In this case, the image may be publicly available, but only authorized users, such as family members, are in possession of the decryption key providing visual access to the child's image content.

Another application is encoding and selective encryption of critical regions of video data to protect premium content for video distribution purposes. The most direct application of the present invention is treatment of each video frame as a separate still image prior to application of the secure coding scheme to the images. Alternatively, the secure coding scheme of the present invention may be applied to proprietary or standard object-based coding schemes, for example MPEG-4. In addition to the operations performed in still object-based coding, these object-based video coding schemes generally take into account the temporal relationship between the video frames by way of motion estimation for inter-frame prediction. The secure coding scheme of the present invention may be applied to these object-based video coding schemes by encrypting the object-data that is utilized in inter-frame prediction. In general, for both still and video object-based coding schemes, the invention involves encrypting the bits of coded data that are required to be able to decode to produce an object of the same visual likeness as the original before coding.

In systems such as IPTV, for example, free baseline content may be distributed along with premium content that is protected with the selective encryption. In this scenario, those who have paid subscription fees would possess the correct decryption key allowing access to the premium content.

The encryption key used for the encryption and decryption process may be generated through algorithmic processes such as random number generation or provided by users. The key can be stored and retrieved using standard cryptographic protocols and systems, such as public key infrastructure (PKI), bound to biometric data using technologies such as biometric encryption, or managed by hardware devices such as trusted platform modules (TPM). When the key is bound to biometric data contained within the protected object itself (such as a face image), the key can only be retrieved when the subject presents their face image again.

The invention may be implemented either as a hardware module, a computer system comprising a computer program executable on the computer system, or a service.

As a hardware module, the present invention can include one or more of the following for execution of the coding, encryption, decoding, and decryption routines: an application specific integrated circuit; programmable circuitry, such as a field programmable gate array (FPGA); a generic processor with associated software written in high or low level programming languages. As a hardware module, the coding, encryption, decoding, and decryption routines may be implemented on one device, or implemented separately on separate devices. For coding and encryption, the device may accept raw or coded video or still images as input via digital or analog interfaces, and output the protected, compressed objects via digital or analog interfaces. For decoding and decryption, the device may accept the protected, compressed objects via digital or analog interfaces, and output the raw or coded video or still images via digital or analog interfaces.

The present invention may also be provided as a computer system comprising a computer program executable on the computer system. The computer program includes computer instructions and data which when made available to one or more computer processors configure the one or more computer processors to provide a secure encoding and decoding utility. The secure coding and decoding utility enables the coding, encryption, decoding, and decryption routines of the present invention.

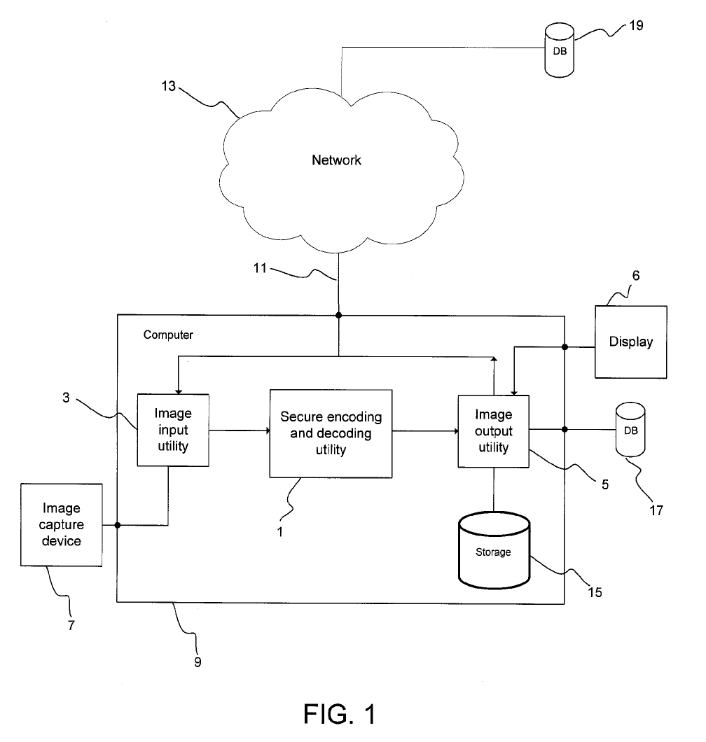

FIG. 1 illustrates the present invention implemented on a computer system wherein the secure coding and decoding utility is a computer program executable on the computer system. The secure coding and decoding utility 1 can be implemented using high or low level programming languages, such as C, C++, Java, Assembly, C#, MATLAB, etc., running on a computer 9 with a generic processing unit. For coding and encryption, the secure coding and decoding utility 1 could accept raw or coded video or still images from an image input utility 3 via software interfaces, and output to an image output utility 5 the protected compressed objects via software interfaces. The image input utility 3 may be operable to interface with an image or video capture device 7 via hardware interfaces of the computer 9 or be linked to a network connection 11 for enabling secure coding of images received from a network 13. The image output utility 5 may be linked to an internal or external storage means, such as a memory 15 or database 17, or a network connection 11 further linked to a network connected storage means 19 for communicating the securely coded images for storage. The image output utility 5 may also be linked to one or more displays 6, for example a computer monitor or television display, for viewing of securely encoded images or of decoded and decrypted images. The one or more displays could be linked through a display interface of the computer or could be located remotely from the computer, linked for example through the network 13. For decoding and decryption, the computer program will accept the protected, compressed objects via software interfaces, and output the raw or coded video or still images via software interfaces.

The secure coding and decoding utility can be implemented locally at a point of image capture, for example on a computer locally connected to a surveillance camera system. Alternatively, the secure coding and decoding utility can be implemented remotely from the point of image capture, for example on a server computer connected by network connection to a surveillance camera system. The latter implementation may be advantageous, for example, where a surveillance camera system could be vulnerable to theft this implementation enables securely encoded images to be safely located at a remote location.

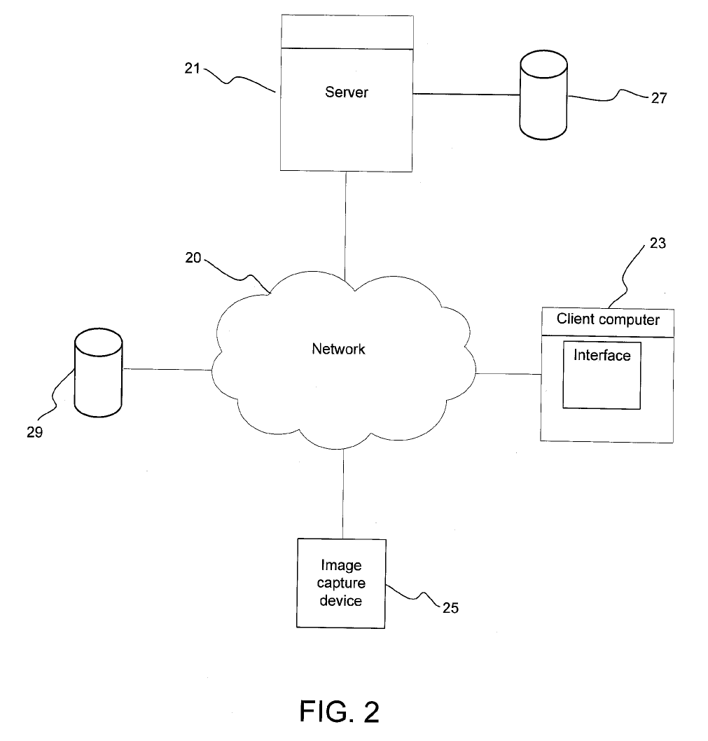

Furthermore, the present invention can be implemented as a service. FIG. 2 illustrates the present invention implemented as a service. The service can be provided as a software as a service (SaaS) implementation. The service includes one or more network 20 connected servers 21, such as web servers, that provide the secure coding and decoding utility. The service also includes access to the one or more servers 21, for example by a web interface accessible on a network 20 connected client computer 23 or a or proprietary interface accessible from a client image capture device 25, which advantageously could be provided using a secure communication protocol such as https. The interfaces could be user interfaces or could be provided as low level machine interfaces for automated usage. Access could be provided on a public (open) basis or on a private (credential) basis. The secure coding and decoding utility can be linked to a local database 27 or network connected database 29 that could be used to store the securely coded images and could be used to provide each individual or device using the service with its own encryption key. The individuals or devices can be associated with their respective key by requiring each individual or device to authenticate to the system or by tracking a location or source of each individual or device, for example using an IP or MAC address associated with the client computer 23 or image capture device 25 that the individual is operating on.

Similarly to the remotely located computer program implementation, the service implementation enables securely coded images to be safely located at a remote location.

The service can be administered by a trusted service provider, which for example includes a government authority or corporate compliance authority. More particularly, a privacy commissioner or privacy officer could administer the service and regulate those individuals that are granted access to the securely encoded images and access to the decoded and decrypted images.

In one example implementation, surveillance cameras could stream video data to the service using a network connection. The securely coded images can be viewed by individuals for monitoring the locations under surveillance, but those individuals may not be given the key for decrypting and decoding selected objects. However, permitted individuals that may be granted access based on credentials or a legal process defined by an authority, for example a government authority or corporate compliance authority, could be given access to the decryption key for accessing object information.

The invention may be incorporated into existing or new visual surveillance systems via hardware or software interfaces. A point of interface can be any hardware or software connection that is used for the acquisition, transmission, or storage of raw or coded images or video, including: inside still or video cameras; external connectors to still or video cameras; external connectors to network cables, routers, or switches; inside storage servers and devices; external connectors to storage servers and devices; inside output display devices such as monitors and televisions; external connectors to output display devices such as monitors and televisions; inside computation devices such as personal computers, servers, or hardware devices; or external connectors to computation devices such as personal computers, servers, or hardware devices.

### Secure Shape and Texture SPIHT Coding Scheme

The original SPIHT scheme upon which the encoding and decoding methods of the present invention are based manages coordinates of the coefficients using three lists, LSP (list of significant pixel), LIP (list of insignificant pixel) and LIS (list of insignificant set). The LIS represents the list of insignificant texture coefficient sets, the LIP represents the list of insignificant texture coefficients, and LSP represents the list of significant texture coefficients. In addition, SPIHT has two steps: a sorting pass followed by a refinement pass. In the sorting pass, a coefficient is compared with a certain threshold value to compute a significant or insignificant value. In the refinement pass, a coefficient value obtained in the sorting pass is further refined. The sorting pass includes a node test for testing significance of the coefficients of the LIP, and a descendent test for testing significance of the entries in the LIS. When a coefficient in the LIP passes the significance test, the coefficient is moved to the LSP. These lists are further utilized by the presently proposed method.

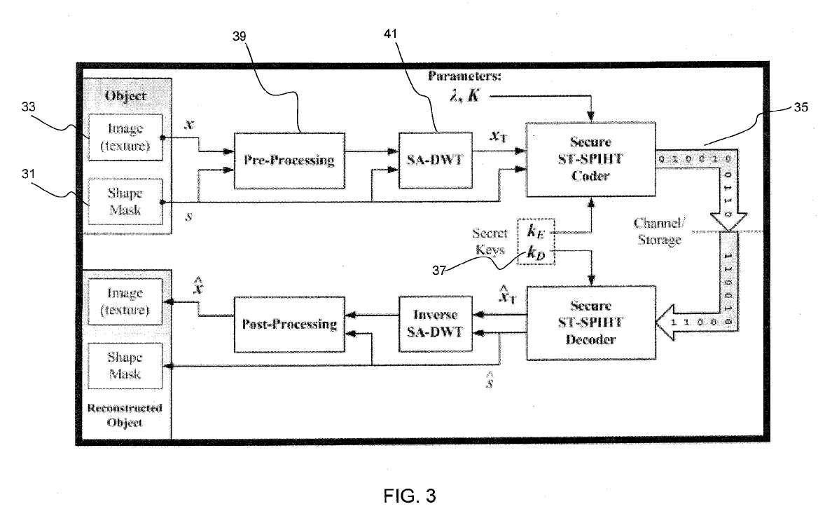

The Secure ST-SPIHT (SecST-SPIHT) coding and decoding scheme system of the present invention is illustrated in FIG. 3. The SecST-SPIHT enables both compression and reversible encryption of an object in an image that is separated from the image background using a single scheme. It employs the Shape and Texture Set Partitioning in Hierarchical Trees (ST-SPIHT) scheme for coding arbitrarily-shaped visual objects with a novel selective encryption scheme that utilizes a stream cipher to encrypt specific bits in the output bit-stream. Any stream cipher may be chosen for this, provided that it is sufficiently secure for the application at hand; that is, the security provided by SecST-SPIHT is based upon the security of the stream cipher it utilizes.

The shape 31 and texture 33 of the input object are coded in parallel, producing a single partially encrypted, embedded bit-stream 35 which can be progressively decoded with provision of the correct decryption key 37; the resultant bit-stream may be truncated at an arbitrary point to produce a lower bit-rate output. The selective encryption offers an efficient alternative to complete content encryption which can be computationally burdensome in full color image and video applications.

The data-dependent decoding scheme makes the unencrypted portion of the bit-stream effectively impossible to locate or interpret. Furthermore, the bits chosen for encryption represent the most significant components of the coded object, ensuring complete confidentiality of the visual data from those without the correct decryption key. Since encryption is performed during the output stage, SecST-SPIHT offers identical rate-distortion performance and embedded/progressive output properties as ST-SPIHT. The proposed system describes secure coding of still visual objects but can easily be extended to the frames of a video object sequence in a fashion similar to Motion JPEG 2000 [14], or using 3-D transform domain representations.

The input consists of two components: (a) an M×N full color (texture 33) image x: Z²→Z³ representing a two-dimensional matrix of three-component RGB color samples x(i,j)=[x(i,j)₁, x(i,j)₂, x(i,j)₃], with i=0, 1, . . . , M−1 and j=0, 1, . . . , N−1 denoting the spatial position of the pixel, and k denoting the component in the red (k=1), green (k=2), or blue (k=3) color channel; and (b) an M×N binary (shape mask 31) image s: Z²→{0,1} representing a two-dimensional matrix of binary values where s(i,j)=1 denotes spatial positions ‘inside’ (i.e. within the borders of) the object, and s(i,j)=0 denotes spatial positions ‘outside’ (i.e. outside the borders of) the object. The object is preprocessed 39 by first converting the texture 33 to the YC_{b}Cᵣ color space. Subsequently, texture positions outside the object are set to zero, such that x(i,j)=[0,0,0], ∀ (i,j) where s(i,j)=0.

Each color channel of the texture is subsequently transformed using an in-place lifting shape-adaptive discrete wavelet transform (SA-DWT) with global subsampling 41 [1], [2], creating the M×N vectorial field x_{T}: Z²→Z³ of transform coefficients x_{T} (i,j)=[x_{T}(i,j)₁, x_{T}(i,j)₂, x_{T}(i,j)₃]. The in-place SA-DWT 41 allows the spatial domain shape mask s 31 to remain unmanipulated and coded directly.

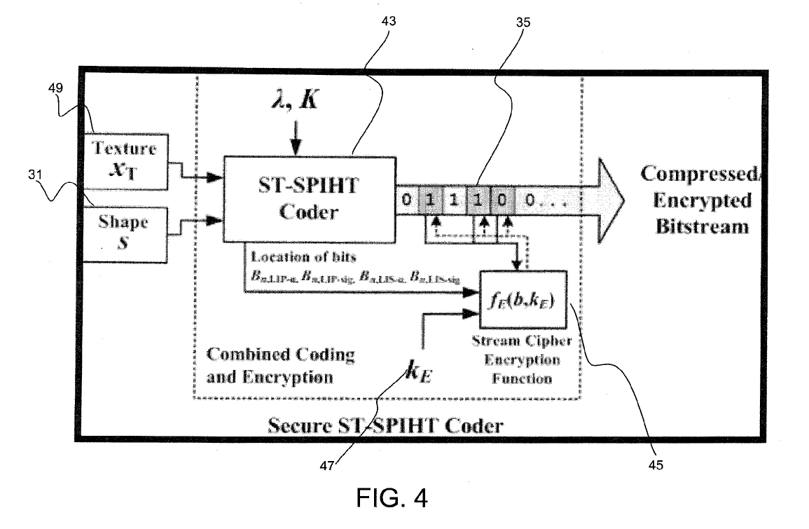

The SecST-SPIHT coder as depicted in FIG. 4 employs an ST-SPIHT coder 43 and selectively encrypts the output bit-stream 35 using a stream cipher f_{E} (b,k_{E}) 45, applied to individual bits b using the private key k_{E} 47. The ST-SPIHT scheme is utilized to code the input shape 31 and texture 49 as well as to provide intelligent bit classification instructions to the stream cipher 45.

The SecST-SPIHT selective encryption scheme is a novel extension of the scheme proposed in [18] for regular SPIHT. By extending the selective encryption principle to object based coding, the encryption of arbitrary image regions is achieved. We denote the ST-SPIHT bit-stream as the ordered set of bits B. The bit-stream can be divided into the ordered subsets B={Bₙₘₐₓ, Bₙₘₐₓ₋₁, Bₙₘₐₓ₋₂, . . . } where Bₙ is the set of bits obtained during coding iteration for bit-plane n (i.e., representing the value 2ⁿ), and nₘₐₓ is the highest bit-plane at which coding is initiated. Each Bₙ can be further subdivided into Bₙ={B_{n,LIP}, B_{n,LIS}, B_{n,LSP}}, where B_{n,LIP} denotes the ordered set of bits obtained during the first phase of the sorting pass where coefficients in the LIP are tested for significance; B_{n,LIS} denotes the ordered set of bits obtained during the second phase of the sorting pass where entire trees are tested for significance; and B_{n,LSP} denotes the ordered set of bits obtained during the refinement pass.

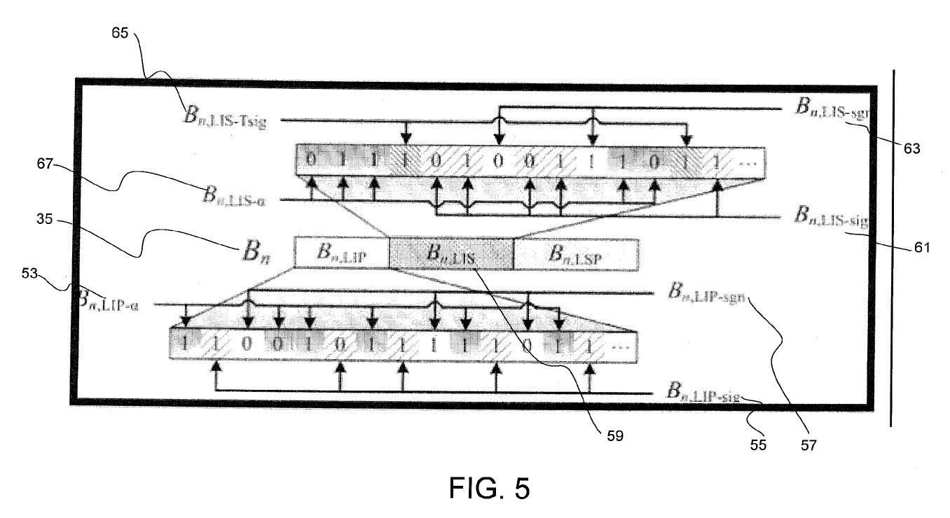

This decomposition of the bit-stream 51 is shown in FIG. 5. Each set of bits B_{n,LIP} is composed of α-test shape bits (B_{n,LIP-α}) 53, significance bits (B_{n,LIP-sig}) 55 and sign bits (B_{n,LIP-sgn}) 57. Similarly, each set of bits B_{n,LIS} 59 is composed of significance bits (B_{n,LIS-sig}) 61 and sign bits (B_{n,LIS-sgn}) 63 for individual coefficients, significance bits for trees (B_{n,LIS-Tsig}) 65, and α-test shape bits for both individual coefficients and trees (B_{n,LIS-α}) 67.

The SecST-SPIHT encryption scheme uses an encryption function ƒ_{E} (b,k_{E}) to encrypt only the bits b∈Bₑ={B_{n,LIP-α}, B_{n,LIP-sig}, B_{n,LIS-α},B_{n,LIS-sig}}, for n=nₘₐₓ, nₘₐₓ−1, . . . nₘₐₓ−K+1, and K>0. The key k_{E} enforces the confidentiality of the data by preventing entities without the correct matching decryption key, k_{D}, from correctly decrypting the data. The parameter K may be controlled by the user at the time of encryption/encoding to determine the number of coding iterations to be encrypted. Increasing K results in more bits being encrypted and greater security, with the trade-off of greater computational overhead. The specific bits may be selectively chosen since they represent the object shape information and the significance information of individual coefficients. The coefficient sign bits (B_{n,LIP-sig} and B_{n,LIS-sig}) may remain unencrypted since their values do not affect the coder/decoder execution path. Similarly, the significance bits relating to entire trees (B_{n,LIS-Tsig}) may remain unencrypted since they do not affect specific coefficient reconstruction values.

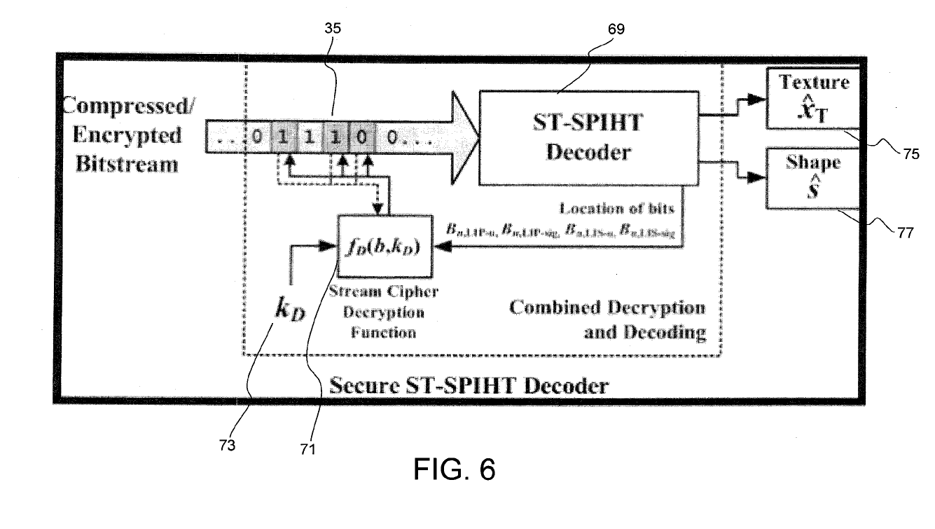

The encryption function ƒ_{E} (b,k_{E}) is implemented using a stream cipher since the decoder 69 as illustrated in FIG. 6 must decode individual bits and instruct the decryption function ƒ_{D} (b,k_{D}) 71 whether each subsequent bit requires decryption or not. Any bit-level stream cipher may be used, employing either symmetric private keys or public-private key pairs.

For ease of notation, the controlled encryption function ƒ_{cE} (b,k_{E}, n, K) is defined as follows:

$${f}_{cE} ( b , {k}_{E} , n , K ) = \{ \begin{matrix}{f}_{E} ( b , {k}_{E} ) , & n > {n}_{max} - K \\ b , & otherwise .\end{matrix} \qquad ( Eq . 1 )$$

Hence, the encryption function is only activated for the first K iterations of the coding scheme, after which the input bits are passed through, unencrypted.

The coding operation is typically terminated when a specified rate or distortion criterion is met. While SecST-SPIHT allows for coding to be terminated before the shape has been losslessly coded, typical rate criteria and values of λ will result in complete lossless coding of the shape. Also, the coder may be instructed not to code the shape in situations where, for example, the shape is implicitly available via the shape of another object which surrounds the object to be coded (e.g., a background object).

The SecST-SPIHT decoder 69 follows the same execution path as the coder and only requires basic initialization information (i.e. M, N, |G|, nₘₐₓλ, K, the number of wavelet transform levels, and s if the shape was not coded) to interpret the output bit-stream 35. Provided with the correct decryption key, k_{D} 73, the decoder decodes the bit-stream and instructs the decryption function ƒ_{D}(b,k_{D}) 71 as to whether each subsequent bit should be decrypted or passed through, unencrypted. Since the first bit is always in B_{nmax,LIP-α} (generated from the first iteration of step 2.1.1), it must always be decrypted. An alternative approach to implementing the coder and decoder would be to set the total number of bits to encrypt, |Bₑ|, rather than K. Encryption would only be activated until this criterion is met; accordingly, provided with this parameter, the decoder can determine which bits in the output bit-stream require decryption.

It should be noted that SecST-SPIHT is backward compatible such that when the input shape s fills the entire M×N rectangular bounding box, the coding operation is identical to traditional SPIHT [3] and the selective encryption scheme operates the same as in [18]. Also, the selective encryption may be applied ‘offline’ to an object already coded using ST-SPIHT. Using an ST-SPIHT decoder to interpret the bit-stream, the equivalent bit classification instructions can be generated as in the SecST-SPIHT coder, and the appropriate bits replaced with encrypted versions.

The SecST-SPIHT decoder reproduces the texture 75 and shape 77 of the object.

### Security Analysis of SecST-SPIHT

The SecST-SPIHT selective encryption ensures the confidentiality of the coded visual object data in two ways: (a) securing the most significant portion of the bit-stream using a secret cryptographic key k_{E} and a stream cipher; and (b) making the unencrypted portion of the bit-stream impossible to decode since its location and the state of the decoder cannot be determined without correct decryption and decoding of the encrypted portion.

As noted in the previous section, encryption is performed on the output bits b∈Bₑ={B_{n,LIP-α}, B_{n,LIP-sig}, B_{n,LIS-α}, B_{n,LIS-sig}|nₘₐₓ−K<n≦nₘₐₓ}. This represents a partial bit-plane and shape encryption performed on the visual object in the SA-DWT domain, with the choice of K determining how many bit-planes to which the selective encryption is applied. A coefficient x_{T} (i,j)ₖ will have its most significant bit (MSB), at bit-plane n_{MSB}(i,j)ₖ=floor(log₂ (|x_{T} (i,j)ₖ|)) encrypted if n_{MSB}(i,j)ₖ>nₘₐₓ−K—i.e., if the coefficient is found significant during the first K coding iterations. Also, if the coefficient is part of the luminance SA-DWT LL subband (i.e., (i,j)ₖ∈H), it is placed in the LIP upon initialization of the coder and hence will also have each bit encrypted in bit-planes max(n_{MSB}(i,j)ₖ, nₘₐₓ−K+1)≦n≦nₘₐₓ. In other words, for luminance LL subband coefficients, the higher order bits are also encrypted, until the bit-plane at which the coefficient is found significant, or K coding iterations have passed. Alternatively, if x_{T}(i,j)ₖ is contained in a spatial orientation tree (i.e., (i,j)ₖ∉H), it will have one or more bits encrypted if it has been removed from the tree and placed in the LIP during the first K coding iterations. This occurs if the parent of coefficient x_{T}(i,j)ₖ has other descendants found significant during the first K coding iterations, before x_{T}(i,j)ₖ is found significant. Defining the parent coordinates of coefficient x_{T}(i,j)ₖ as P(i,j)ₖ, as per the color spatial orientation tree definition we then define the set of coordinates of ‘parental descendants’ x_{T}(i,j)ₖ as D_{P}(i,j)ₖ=D(P(i,j)ₖ)\(i,j)ₖ}. That is, the parental descendants of x_{T}(i,j)ₖ are all the coefficients descendant from its parent, not including itself. Hence, if max_{(r,s)t∈DP(i,j)k}(n_{MSB}(r,s)ₜ)>n_{MSB}(i,j)ₖ and max_{(r,s)t∈DP(i,j)k}(n_{MSB}(r,s)ₜ)>nₘₐₓ−K, then coefficient x_{T} (i,j)ₖ will be placed in the LIP during the first K coding iterations, and will have encrypted bits in the bit-planes max(n_{MSB}(i,j)ₖ, nₘₐₓ−K+1)≦n≦max_{(r,s)t∈DP(i,j)k}(n_{MSB}(r,s)ₜ). The net effect of this is that a non-significant coefficient will still have one or more of its bits encrypted if it is located in the region of significant coefficients, thus the partial encryption can be seen to be applied in general regions of significance.

In addition to the partial bit-plane encryption of the texture coefficients, the output of each α-test is encrypted, effectively encrypting the entire shape code during the first K iterations. If K>nₘₐₓ−λ, then the complete, lossless shape code is encrypted. The choice of K should be made to ensure that the number of bits finally encrypted is sufficient to make it computationally infeasible to perform a brute-force, exhaustive search attack over all possible sequences.

As with SPIHT and ST-SPIHT, the SecST-SPIHT coder and decoder follow a data-dependent execution path. This means that the correct interpretation of a given bit in the output bit-stream requires complete knowledge of all previous significance test and α-test bits. The result is that an attacker cannot in fact locate the bits in the output bit-stream which are not encrypted. To demonstrate the difficulty encountered by a cryptanalyst attempting to determine which bits are unencrypted, we use b^{j}_{n,LIP} to denote the j^{th} bit in the set B_{n,LIP}, for j=0, 1, 2, . . . N_{n,LIP}−1, where N_{n,LIP} is the total number of bits in B_{n,LIP}. According to the SecST-SPIHT coder definition, considering the initial coding iterations in which n≧λ (i.e., the shape is still being coded), it is known a priori that the first bit is an α-test bit:

b_{n,LIP}⁰∈B_{n,LIP-α} (Eq. 2)

However, classification of the second bit depends on the first bit:

$${b}_{n , LIP}^{1} ∈ \{ \begin{matrix}{B}_{n , LIP - sig} , & if {b}_{n , LIP}^{0} = 1 \\ {B}_{n , LIP - α} , & otherwise\end{matrix} \qquad ( Eq . 3 )$$

And, consequently, classification of the third bit depends on the first and second bits:

$${b}_{n , LIP}^{2} ∈ \{ \begin{matrix}{B}_{n , LIP - sig} , & if ( {b}_{n , LIP}^{0} = 0 \\ & and {b}_{n , LIP}^{1} = 1 ) \\ {B}_{n , LIP - sgn} , & if ( {b}_{n , LIP}^{0} = 1 \\ & and {b}_{n , LIP}^{1} = 1 ) \\ {B}_{n , LIP - α} , & otherwise\end{matrix} \qquad ( Eq . 4 )$$

This can be generalized as follows:

$${b}_{n , LIP}^{j} ∈ \{ \begin{matrix}{B}_{n , LIP - sig} , & if ( {b}_{n , LIP}^{j - 1} ∈ {B}_{n , LIP - α} \\ & and {b}_{n , LIP}^{j - 1} = 1 ) \\ {B}_{n , LIP - sgn} , & if ( {b}_{n , LIP}^{j - 1} ∈ {B}_{n , LIP - sig} \\ & and {b}_{n , LIP}^{j - 1} = 1 ) \\ {B}_{n , LIP - α} , & otherwise\end{matrix} \qquad ( Eq . 5 )$$

for 1≦j<N_{nLIP}. From (Eq. 5), it is evident that the bits B_{n,LIP} can in fact be treated as the ordered set of coded transition instructions in a Markov chain. The classification of b^{j-1}_{n,LIP} indicating the (j−1)^{th} state in the chain, must be known along with the value b^{j}_{n,LIP} (the transition instruction) in order to determine the classification of b^{j}_{n,LIP} (the j^{th} state in the chain). Since the value of b^{j}_{n,LIP} indicates only the transition and not the state itself, it is clear that all previous bits b¹_{n,LIP} 0≦l>j must be known in order classify b^{j}_{n,LIP} and determine whether it is unencrypted. Similar arguments can be made for B_{n,LIS}. Hence, without the correct decryption key, not only do the encrypted bits remain confidential, but the locations of the unencrypted bits cannot be determined and are thus also confidential.

In attacking the encrypted portion of the bit-stream, the cryptanalyst may attempt to recreate the Markov chain and perform statistical analyses so that the original bits could be correctly predicted with probability p>0.5 from previous bits, thus aiding an exhaustive search attack. The efficiency of the coding scheme [1], [3] implies that the entropy of each bit H(b)≈1 and thus p≈0.5, regardless of the additional contextual information offered by the previous states in the decoded chain. However, if a more conservative estimate of H(b)<1 is made, then K can simply be increased to increase the number of encrypted bits in order to ensure that an exhaustive search remains computationally infeasible. Also, it should be noted that, as with traditional cryptographic systems, the length of the decryption key, k_{D}, should also be long enough to defend against a brute-force attack over the key space.

Alternatively, an attacker may attempt to locate the unencrypted portion of the bit-stream Bᵤ={Bₙ|n≦nₘₐₓ−K} since it is known that all bits in Bᵤ are unencrypted, and may reveal important image features if correctly decoded. If we denote the total number of bits in the first K coding iterations (both encrypted and unencrypted) as N_{K}, an attack on Bᵤ may be attractive if H(Bₑ)>H(N_{K}). In other words, if determining the location of Bᵤ (which starts at bit N_{K}+1 within the overall bit-stream B) is computationally simpler than an exhaustive search over the encrypted bits Bₑ, the attacker may view this approach as offering greater probability of success in revealing image details. However, even with knowledge of Bᵤ, the state of the LSP, LIP, and LIS lists and the shape decoding remain unknown without correct decryption and decoding of Bₑ. This means that while the initial bits in Bᵤ may be correctly classified by the attacker, it cannot be determined which coordinates within the SA-DWT representation of the object the coded bits correspond to. Ultimately, the attacker will not be able to determine any image details from Bᵤ without correct decryption and decoding of Bₑ.

In summary, the SecST-SPIHT secure coder achieves confidentiality by encrypting the most significant portion of the bit-stream as well as obfuscating the unencrypted portion. The scheme in [21] applies a similar approach for zero-tree wavelet coded rectangular images, except that an a priori design choice is made to restrict encryption to the lowest two frequency subbands (i.e., the top two levels in the spatial orientation trees). This approach does not allow for the data-dependent distribution of significant coefficients and is inflexible to varying applications which require input images of different sizes with the use of varying number of wavelet decomposition levels. In contrast, the approach of SecST-SPIHT is for the selective encryption to follow the data-dependent execution path of the coder, ensuring that the most significant coefficients, regardless of location, are partially encrypted, and that always the initial portion of the bit-stream is partially encrypted. Furthermore, SecST-SPIHT offers the user parameter K which provides control over how many coding iterations are considered for encryption. This allows flexibility to meet the security requirements of the application at hand. In practice, choosing K=1 may result in a sufficient number of bits being encrypted to prevent a successful brute-force attack (see Table I). In other words, for K=1, the number of encrypted bits |Bₑ|>>128, representing the current standard for the minimum length of “strong” binary keys. However, it is possible that the states of the LSP, LIP, and LIS lists may not be sufficiently random after a single coding iteration, potentially aiding a brute-force attack. As such, it is recommended to choose K=2 to protect against intelligent attacks. For critical applications where security is of greater importance than processing overhead, practitioners may choose K>2.

### Experimental Results:

The analyses of the SecST-SPIHT coder demonstrates the security of the SecST-SPIHT coder. However, the efficacy of such a scheme must also be demonstrated via subjective visual evaluation to ensure that the secured object details remain confidential. Also, the computational requirements of the scheme must be evaluated via empirical measurement of processing times. Sample visual objects were inputted to the SecST-SPIHT coder and the generated output was evaluated wherein the user does not provide the correct decryption key. The performance of the proposed scheme was judged on its ability to obscure the original visual object features as well as its ability to achieve processing times less than those achieved with ‘whole content’ encryption. The security level parameter K, and shape code level parameter λ, were varied to determine their effect on the processing times and the resultant number of encrypted bits as a portion of the whole bit-stream.

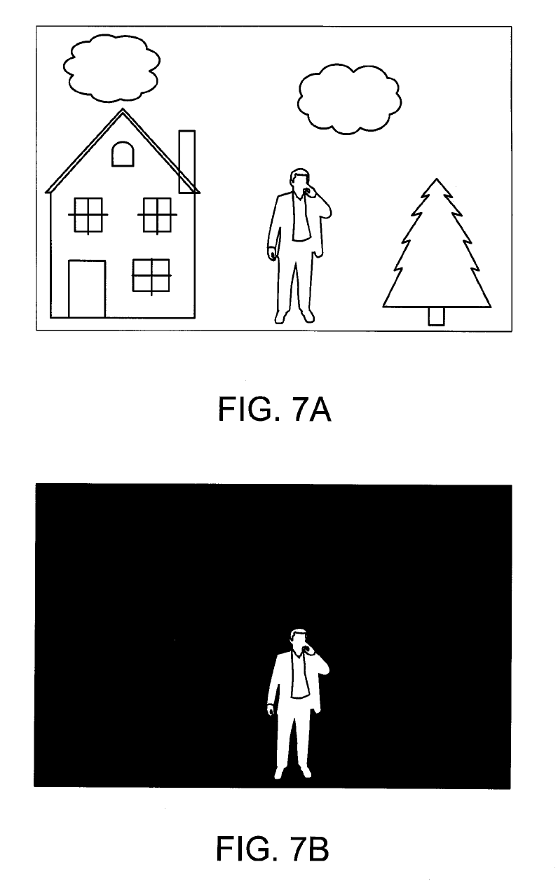

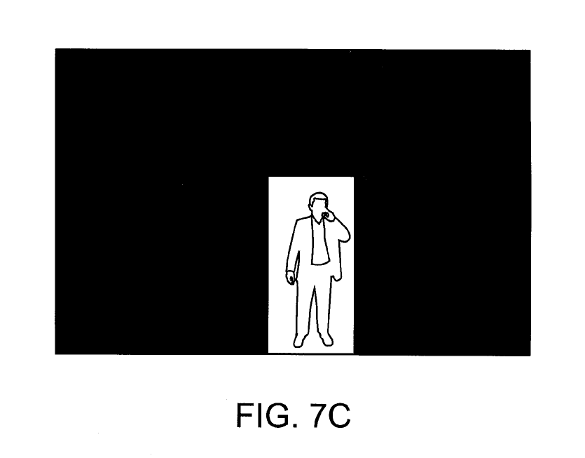

Input visual test objects may be as illustrated in FIG. 7. Objects may be included with bounding box shape representations, simulating the case where “coarse” segmentation is applied. Such a situation may arise in some real-time or low-resolution applications where accurate segmentation is infeasible. The coder accepts an arbitrary binary segmentation map so that any segmentation scheme can be employed, depending on the requirements of the application. All frames could be in 8-bit per channel RGB CIF format (352×288).

The SecST-SPIHT coder may utilize the CDF 9/7 biorthogonal wavelet filters [22] with a 4-level transform, and an output code bit-rate of 2.4 bits-per-object-pixel (including the shape code, where applicable). Since the progressive/embedded output property of ST-SPIHT is maintained, the output code may be arbitrarily truncated to achieve a lower bit-rate with the sacrifice of greater texture distortion. If lossless coding of the texture is required, integer-to-integer wavelet filters [23] and color transforms can be utilized and the coder instructed to code all of the transform domain bit-planes [1]. The HC-128 software-based cipher was employed as a realistic example of a modern stream cipher [24], using a 128-bit randomly generated key. However, any stream cipher that is sufficiently secure for the application can be utilized.

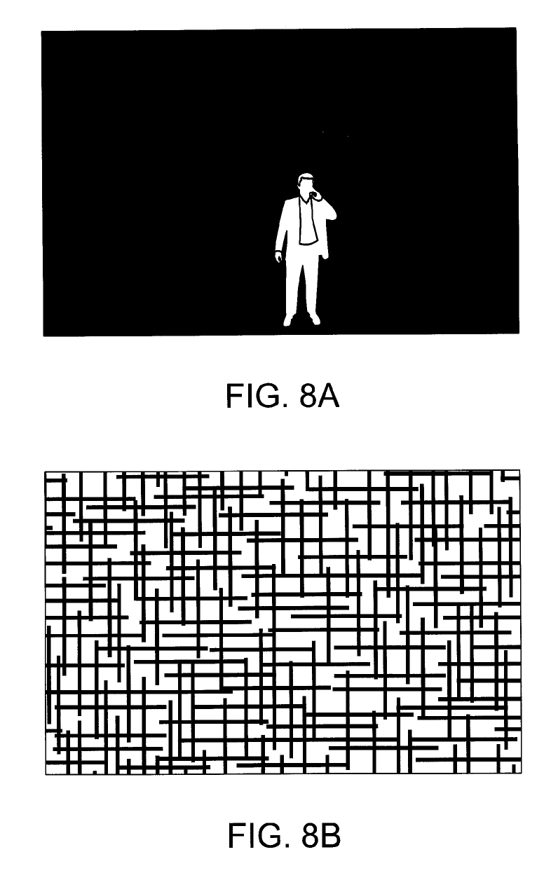

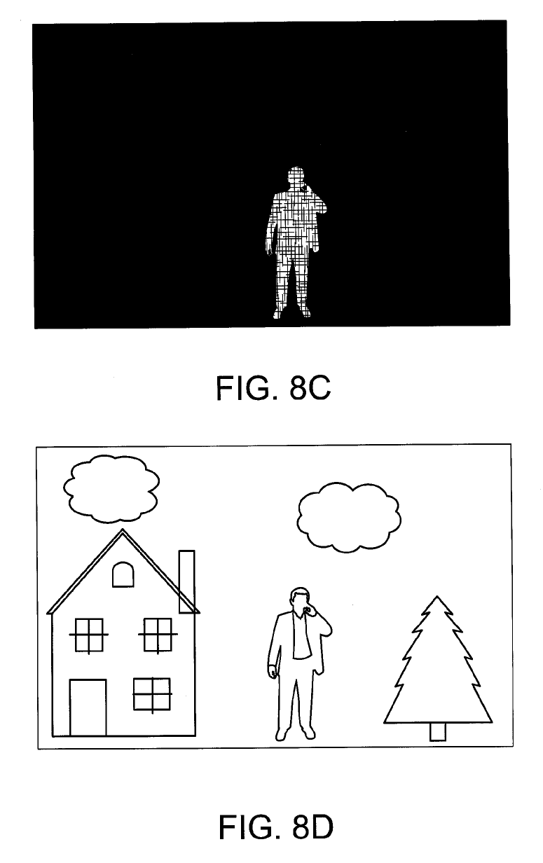

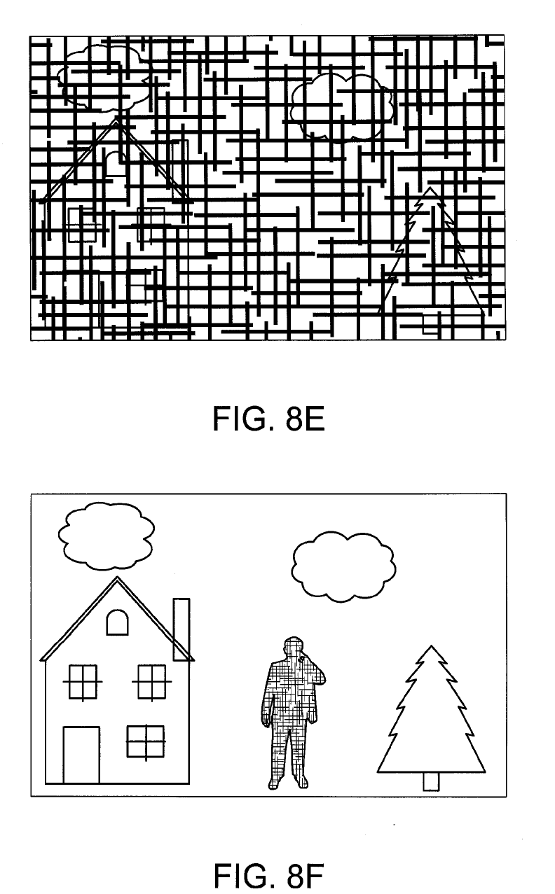

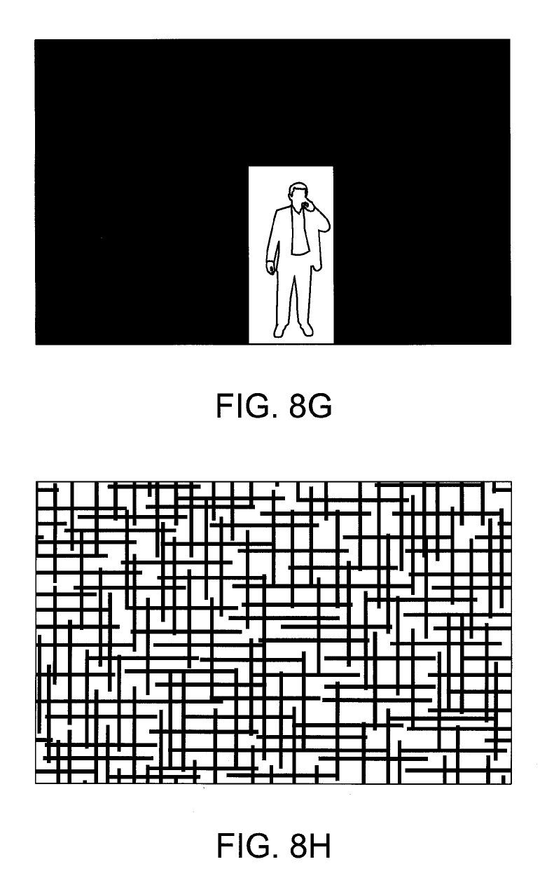

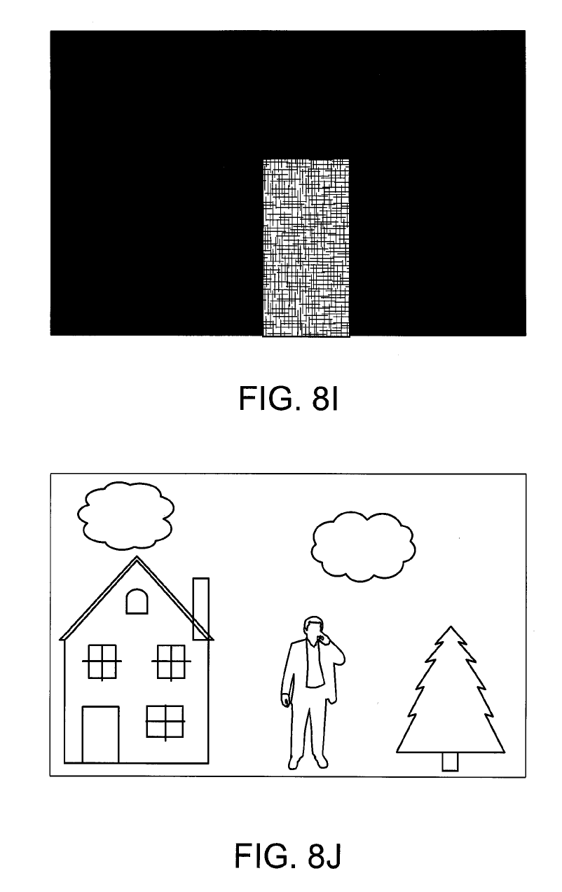

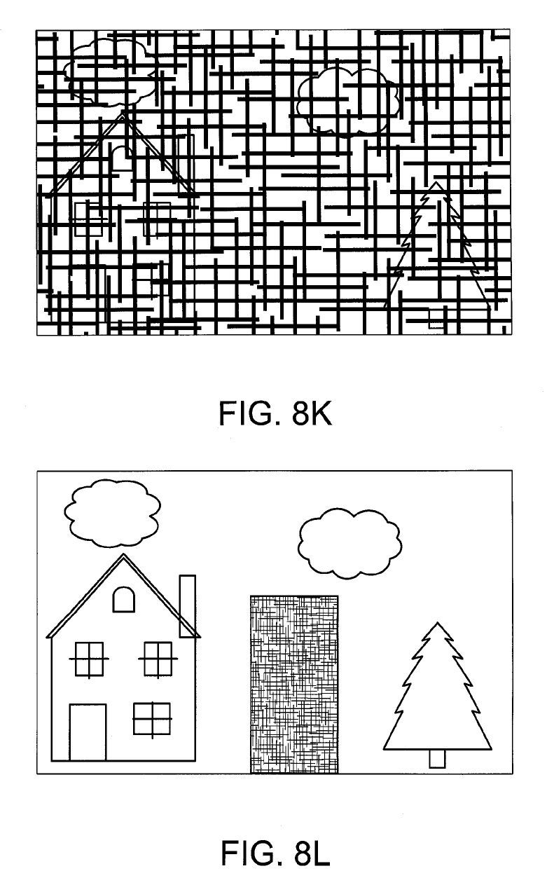

FIG. 8 illustrates sample output using the test object from FIG. 7. In all cases, encryption is performed during the first two coding iterations (K=2). In the cases where the shape is coded and encrypted with the object texture, the shape code is completed in the third iteration (λ=nₘₐₓ−2). FIG. 8 shows the decrypted/decoded output ‘surveillance’ objects/frames when: the correct decryption key was provided (FIGS. 8A and 8D); the incorrect decryption key was provided (FIGS. 8B and 8E); and the incorrect decryption key was provided, but the shape is available externally and only the texture is coded and encrypted (FIGS. 8C and 8F). We note that that the shape may be implicitly provided externally via a background object which surrounds the given object. This is not equivalent to simply turning off encryption (but still coding) for the shape bits since, in this case, the unencrypted shape bits would still be difficult for an attacker to locate and decode amongst the other encrypted content. On the other hand, providing the shape externally gives direct access to the content and allows decoding of the texture in reference to the provided shape. In addition, in FIG. 8, the rectangular bounding box versions of the of the decrypted/decoded object (‘surveillance’-rect) are shown for when: the correct decryption key is provided (FIGS. 8G and 8J); the incorrect decryption key is provided (FIGS. 8H and 8K); and the incorrect decryption key was provided, but the bounding box shape is available externally and only the texture is coded (FIGS. 8I and 8L). In all cases where the incorrect key is provided, the textural content is completely obscured; no object details can be seen. For the cases shown in FIGS. 8B, 8E, 8H and 8K where the shape is coded and encrypted with the texture, the shape is also completely obscured. In order to reconstruct the frame without revealing the object shape mask, the background is transmitted as a full frame, with the missing texture information behind the object filled-in using prior frames.

Comparing the output of the accurately segmented objects with the bounding box segmented objects, it can be seen that the same level of obscuration is achieved when the shape is coded and encrypted (i.e., comparing FIGS. 8E and 8K). However, in the cases where the shape has been provided externally, the accurate segmentation (FIG. 8F) may reveal silhouette details which could be used to identify subjects [9]. In contrast, the coarse bounding box (FIG. 8L) completely obscures the actual shape of the object. The trade-off in this case is that the liberal nature of the bounding box segmentation map results in a large portion of the frame being obscured, reducing the ability to monitor general activities that occur in the frame.

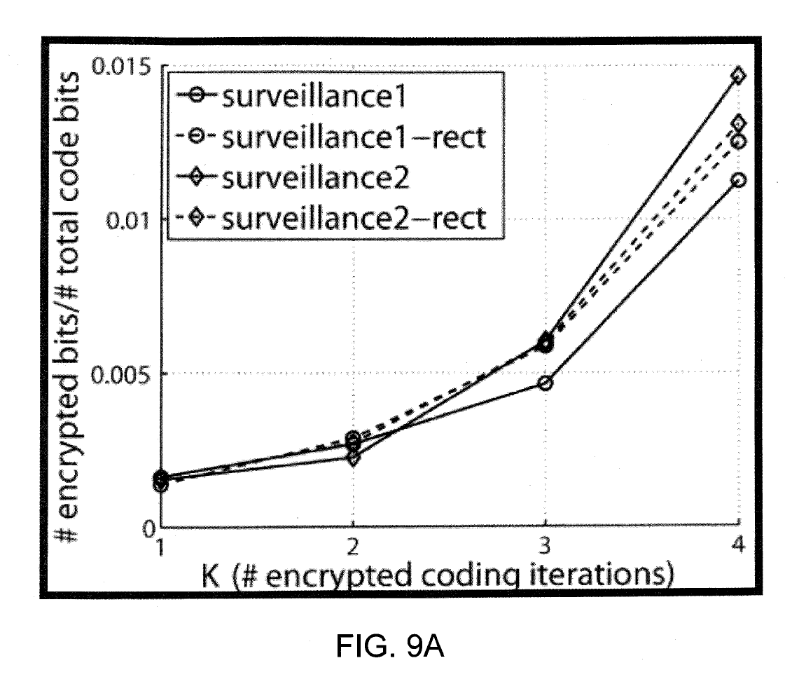

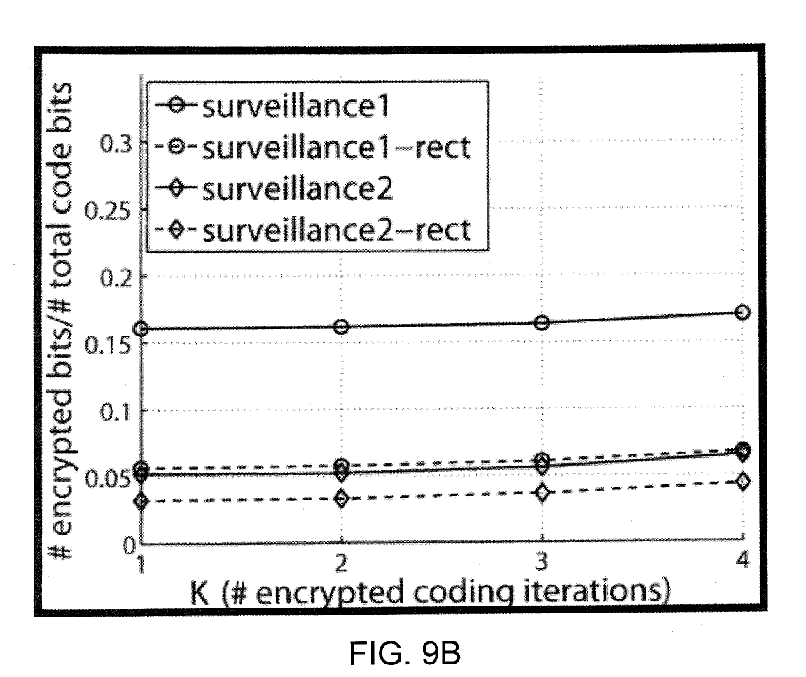

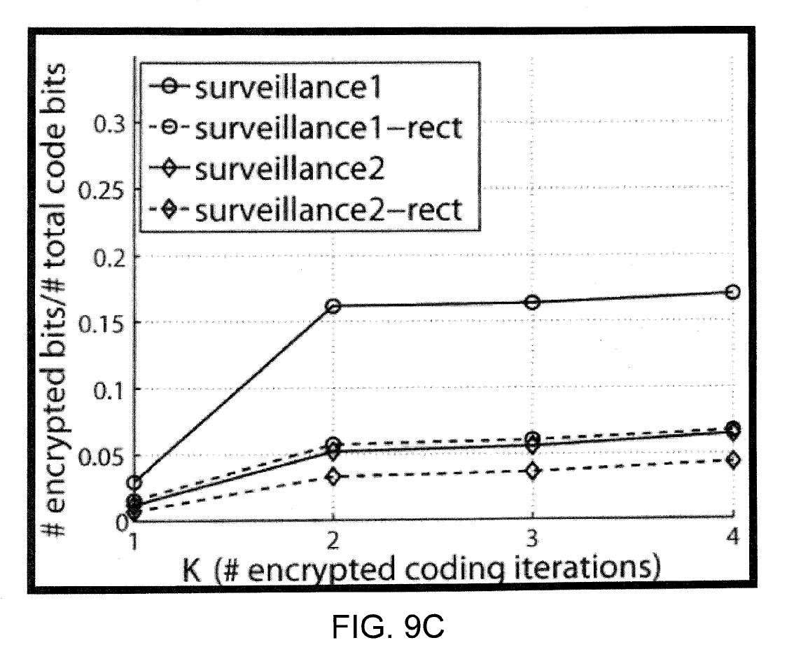

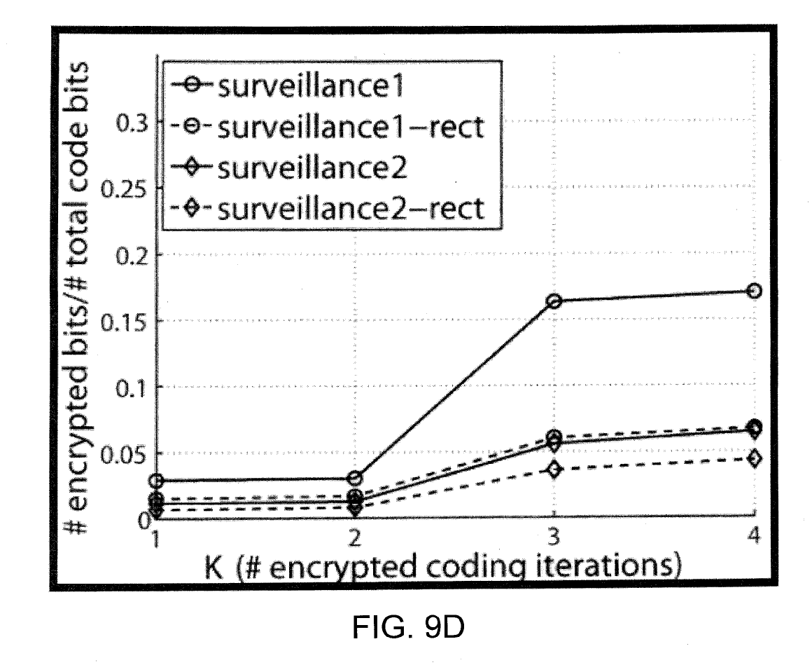

FIG. 9 shows the fraction of the output code bits which are encrypted vs. the number of coding iterations during which encryption is performed (K) for two particular input visual test objects. The total number of output code bits corresponds to a bit-rate of 2.4 bits-per-object-pixel (including the shape code for FIGS. 9B to 9D). FIG. 9A shows the case where the shape is not coded; FIGS. 9B to 9D show the cases where the shape code is completed during the first, second, and third coding iteration (λ=nₘₐₓ, nₘₐₓ−1 and nₘₐₓ−2) respectively. In FIG. 9A, the effect of varying K can clearly be seen, with the fraction of the output code being encrypted rising with K. The fraction remains small for all considered K=1, . . . , 4, ranging from approximately 0.2% to 1.6%. In FIGS. 9B to 9D, a large jump in the portion of the bit-stream that is encrypted is observed once K is set high enough to ensure that the shape is completely encrypted (K=nₘₐₓ−λ+1). When K is raised above this point, the effect is more subtle since at low output bit-rates the shape code represents a significant portion of the bit-stream. With K>nₘₐₓ−λ the actual percentage of the output code that is encrypted is largely controlled by the portion which is the shape code (B_{n,LIP-α and B}_{n,LIS-α}). If the user wishes to keep the level of encryption to a minimum for the purpose of computational efficiency, λ should be set low enough to disperse the shape code further into the bit-stream, and setting K≦nₘₐₓ−λ so that only the initial portion of the shape code is encrypted. In this case, λ should be chosen so that K can still be set high enough to encrypt a minimum number of bits to achieve a minimum desired level of security. For example, as in FIG. 7, setting K=2 and λ=nₘₐₓ−2 (i.e., shape code completed in the third coding iteration). The drawback of this approach is that the shape cannot be completely, losslessly decoded until later in the output bit-stream, possibly resulting in lossy shape reconstruction in very low bit-rate scenarios.

It should be noted that as FIGS. 8B, 8E, 8H and 8K show cases where the shape is only partially encrypted (i.e., K<nₘₐₓ−λ), the shape is still entirely obscured. Using K≧nₘₐₓ−λ (i.e., entirely encrypting the shape) does not provide any further visual obscuration of the shape. Hence, justification for employing greater K should be based purely on the cryptanalysis, and not on visual inspection.

TABLE I
The number of bits encrypted for the test objects using different
values of K and λ = nₘₐₓ − 2

K

| Test Object | 1 | 2 | 3 | 4 |
|---|---|---|---|---|
| ‘Surveillance1’ | 777 | 805 | 4333 | 4507 |
| ‘Surveillance1’-rect | 778 | 858 | 3070 | 3406 |
| ‘Surveillance2’ | 734 | 790 | 3494 | 4030 |
| ‘Surveillance2-rect | 717 | 847 | 3785 | 4524 |

Table I shows the number of bits encrypted for λ=nₘₐₓ−2 and different K. As in FIG. 9D, there is a jump at the iteration at which the remaining shape code is generated and encrypted (K=3). With this choice of λ, K=2 can be chosen since the number of bits encrypted is large enough to prevent a brute-force, exhaustive search attack over the encrypted bits, but still represent minimal processing overhead with less than 5% of the output bit-stream encrypted for a bit-rate of 2.4 bits-per-object-pixel. It should be noted that for a given object and chosen K (i.e., fixed number of encrypted bits), if the output bit-rate is decreased, the percentage of the output bits that are encrypted rises proportionally. This is necessary to ensure the confidentiality of the coded information, regardless of output bit-rate or reconstruction quality. That is, K should be chosen based on the security requirements, independent of the image quality employed by the system.

The results in FIG. 9 show that use of the rectangular bounding box segmentation mask results in no appreciable difference in the fraction of bits encrypted when compared to the accurate segmentation map. However, Table I shows that the absolute number of bits encrypted increases in the range of approximately 10% to 20% for the rectangular bounding box. This is a direct result of the bounding box containing more pixels than the accurate segmentation mask.

TABLE II
Processing times in seconds for coding and encryption using different
values of K and λ = nₘₐₓ − 2

| | K | | | | | |
|---|---|---|---|---|---|---|
| | No | | | | | |
| Test | Encryp- | | | | | |
| Object | tion | 1 | 2 | 3 | 4 | 5 |
| ‘Surveillance1’ | 0.0120 | 0.0121 | 0.0121 | 0.0123 | 0.0124 | 0.0140 |
| ‘Surveill- | 0.0123 | 0.0124 | 0.0124 | 0.0126 | 0.0126 | 0.0160 |
| ance1’-rect | | | | | | |
| ‘Surveillance2’ | 0.0125 | 0.0127 | 0.0127 | 0.0128 | 0.0129 | 0.0171 |
| ‘Surveill- | 0.0131 | 0.0132 | 0.0132 | 0.0134 | 0.0135 | 0.0204 |
| ance2’-rect | | | | | | |

Table II shows the processing time in seconds for different values of K, as well as with no encryption (baseline ST-SPIHT), and whole content encryption (encryption of the entire ST-SPIHT bit-stream). The coding and encryption was performed on a Windows XP™ based machine, using an Intel™ Core 2 Duo E6600™ processor at 2.4 GHz. As can be seen, for 1≦K≦4, the processing time compared to the case of no encryption is increased negligibly (<5%). In contrast, encrypting the entire content results in processing times that are between 15% and 75% greater than those achieved with no encryption. It is clear that the partial encryption approach is justified as a method for processing efficiency when a software-based stream cipher is employed. In an environment where multiple surveillance streams must be processed simultaneously, the processing time savings achieved by ST-SPIHT in comparison to whole content encryption can be critical.

It should be noted that the property of SecST-SPIHT to disperse the shape code within the texture code is inherited from ST-SPIHT. With the execution path of the texture decoding dependent on the shape code, the two portions of the code cannot be separated without correct decryption of all encrypted bits.

SecST-SPIHT securely codes both the shape and texture, ensuring confidentiality through the use of a private decryption key. In contrast to privacy protection systems that simply discard the subject's visual details via masking or blurring, SecST-SPIHT allows complete recovery of the data if the correct decryption key is provided. This is necessary in applications where the visual data may be required for future investigative purposes. Furthermore, by encrypting the object shape, subject recognition based on silhouette characteristics is prevented. Additionally, the SecST-SPIHT secure coder offers all the features of the ST-SPIHT visual object coder [1], namely efficient and progressive/embedded parallel coding of the object shape and texture.

The parameter K offers the user control over a variable level of application-dependent security. In effect, increasing K increases the portion of the output bit-stream that is encrypted by performing encryption for a greater number of coding iterations. In practice, K can be chosen to ensure that the number of encrypted bits is high enough to protect against a brute-force, exhaustive search attack over the encrypted portion of the bit-stream. It was demonstrated that K=2 was generally sufficient. The remaining unencrypted portion of the bit-stream cannot be decoded since the data-dependent execution of the decoder requires complete knowledge of the prior (encrypted) portion of the bit-stream.

The provided secure coding scheme operates on individual visual object input frames, but may be applied to video sequences using techniques similar to Motion JPEG 2000 [14] or 3-D transform domain representations [17]. Alternatively, motion compensation may be employed to reduce the size of the shape and texture coded for subsequent frames, such as is done in the MPEG-4 coding standard. Consequently, for a given K, the number of encrypted bits for subsequent encrypted object frames could also be very low. However, confidentiality of those object frames would not be compromised since correct decoding would require decryption of the previous frames, thus extending the data dependent, partial encryption paradigm into the temporal dimension.

SecST-SPIHT is well suited as a privacy enhancing technology for surveillance-intensive environments. However, the coder can be employed in any number of applications where the confidentiality and efficient coding of arbitrarily-shaped visual objects is required.

It should be understood that with increased demand for surveillance and also increased interest in maintaining privacy interest of individuals, except where an overriding interest exists (e.g. investigation of a crime, or proper limits to access of private information are ensured) there is a need for efficient, selective encryption of digital images that also enables retrieval of substantially all of original information, thereby improving the utility of the retrieved information, for example, for identification purposes.

In applications where the integrity of the data upon decryption is of significant importance, such as when the encrypted content is to be used as evidence in a court of law, an authentication module can be added to the system. The authentication module would produce a signature of the data before encryption, such as through the use of a cryptographic hash. Upon decryption of the data, the authentication module would produce a signature of the decrypted data via the same scheme used on the original data, and compare with the original signature. If the signatures exactly match, the authentication module would verify the authenticity of the data.

1. A computer implementable method for securely encoding an image, characterized by the steps of:
a. selecting one or more objects in the image from the background of the image;
b. separating the one or more objects from the background; and
c. compressing and encrypting, or facilitating the compression and encryption, by one or more computer processors, each of the one or more objects using a single coding scheme.

2. The method of claim 1, characterized in that the one or more objects can be decrypted and decoded using the single coding scheme.

3. The method of claim 1, characterized in that the selection of the one or more objects defines a shape mask, the shape mask enabling the compression and encryption of the one or more objects differently than the background.

4. The method of claim 1, characterized in that at least two objects are selected, wherein the single coding scheme is configurable and is applied differently for at least two of the objects.

5. The method of claim 1, characterized in that the one or more objects are arbitrarily shaped.

6. The method of claim 1, characterized in that the background is viewable without requiring decryption and decompression of all of the one or more objects.

7. The method of claim 1, characterized in that the one or more objects include texture and shape, wherein the single coding scheme is configurable and is applied differently to the texture and shape.

8. The method of claim 1, characterized in that the image is one of a plurality of related images defining an image sequence, wherein the single coding scheme is configurable and wherein for each particular object the same coding scheme configuration is applied in each related image.

9. A computer implementable method for encoding an image using a secure ST-SPIHT (Shape and Texture Set Partitioning in Hierarchical Tree) scheme, characterized by the steps of:
a. selecting an object from the image;
b. obtaining in a first color space a matrix of color texture samples of the image;
c. obtaining a shape mask of spatial positions inside the object and outside the object;
d. converting the matrix to a converted matrix in a second color space and applying the shape mask to the converted matrix;
e. transforming the converted matrix to a transformed matrix using a shape-adaptive discrete wavelet transform;
f. coding, or facilitating the coding, by one or more computer processors, the transformed matrix and the shape mask with a ST-SPIHT coder to produce a unified embedded output bit-stream; and
g. selectively encrypting the output bit-stream using a stream cipher applied to individual bits using a private key.

10. The method of claim 9, characterized in that the first color space is RGB and the second color space is YC_{b}Cᵣ.

11. The method of claim 9, characterized in that the spatial positions inside the object are represented in the shape mask by “1” and the spatial positions outside the object are represented in the shape mask by “0”.

12. The method of claim 9, characterized in that the ST-SPIHT scheme codes both the shape and the texture of an image in parallel to produce one unified embedded output bit-stream.

13. The method of claim 9, characterized in that the ST-SPIHT scheme produces either a lossy or lossless code, as chosen by a user.

14. The method of claim 9, characterized in that the level of output bit-stream encryption is controlled by a user.

15. The method of claim 9, characterized in that the ST-SPIHT coder may be instructed not to code the shape mask.

16. The method of claim 9, characterized in that the output bit-stream may be encrypted at any time once coded by the ST-SPIHT coder.

17. The method of claim 9, characterized in that complete recovery of the image is achieved with a correct decryption private key.

18. A computer implementable method for decoding an image using a secure ST-SPIHT (Shape and Texture Set Partitioning in Hierarchical Tree) scheme, characterized by the steps of:
h. decrypting an output bit-stream using a stream cipher applied to individual bits using a private key;
i. decoding, or facilitating the decoding, by one or more computer processors, the bit-stream using a ST-SPIHT decoder to provide incremental instructions to the decryption stream cipher as to which bits to decrypt, and obtain a transformed matrix and a shape mask;
j. inverse transforming the transformed matrix to a converted matrix in a second color space using an inverse shape-adaptive discrete wavelet transform; and
k. converting the converted matrix to a matrix in a first color space for representing color texture samples of the image.

19. The method of claim 18, characterized in that an unencrypted portion of the output bit-stream cannot be decoded without the private key since the decoder requires complete knowledge of a prior encrypted portion of the output bit-stream.

20. A computer system for securely encoding an image, the computer system comprising one or more computers configured to provide, or provide access to, a secure coding and decoding utility, the secure coding and decoding utility characterized in that it is operable to:
l. select one or more objects in the image from the background of the image;
m. separate the one or more objects from the background; and
n. compress and encrypt, or facilitate the compression and encryption, by one or more computer processors, each of the one or more objects using a single coding scheme.

21. The system of claim 20, further characterized in that the secure coding and decoding utility is operable to decrypt and decode each of the one or more objects using the single coding scheme.

22. The system of claim 20, characterized in that the selection of the one or more objects defines a shape mask, the shape mask enabling the compression and encryption of the one or more objects differently than the background

23. A computer program product for securely encoding an image, the computer program product comprising computer instructions and data which when made available to one or more computer processors configure the one or more computer processors to provide a secure encoding and decoding utility, the secure encoding and decoding utility characterized in that it is operable to:
o. select one or more objects in the image from the background of the image;
p. separate the one or more objects from the background; and
q. compress and encrypt, or facilitating the compression and encryption, by one or more computer processors, each of the one or more objects using a single coding scheme.

24. The computer program product of claim 23, characterized in that the secure encoding and decoding utility is operable to decrypt and decode each of the one or more objects using the single coding scheme.

25. The computer program product of claim 23, characterized in that the selection of the one or more objects defines a shape mask, the shape mask enabling the secure coding and decoding utility to securely encode the one or more objects differently than the background.
